(19) United States
(12) Patent Application Publication
(10) Pub. No.: US 2009/0215309 A1
(43) Pub. Date: Aug. 27, 2009

(54) DIRECT ATTACH ELECTRICAL CONNECTOR

(75) Inventors: John Mongold, Middletown, PA (US); Brian Vicich, Prospect, KY (US)

Correspondence Address: SAMTEC INCORPORATED;C/O KEATING & BENNETT, LLP, 1800 Alexander Bell Drive, SUITE 200, Reston, VA, 20191, US

(73) Assignee: SAMTEC, INC., New Albany, IN (US)

(21) Appl. No.: 12/035,582

(22) Filed: Feb. 22, 2008

(51) Int. Cl. H01R 12/24; H01R 43/00

(52) U.S. Cl. 439/495; 29/884

(57) ABSTRACT

An electrical connector includes a connector frame, a plurality of contacts disposed in the connector frame, a plurality of cables, each of which includes at least one center conductor. The at least one center conductor of each of the plurality of cables is directly connected to a respective one of the plurality of contacts.

### BACKGROUND OF THE INVENTION

1. Field of the Invention

The present invention relates to electrical connectors and more specifically, the present invention relates to electrical connector assemblies in which wires or cables are directly attached to a connector contact.

2. Description of the Related Art

Electrical connectors are used to place electrical devices, such as printed circuit boards, in communication with one another. An electrical connector may be thought of as having two portions, one portion of which connects to a first electrical device and the second portion of which connects to a second electrical device to be put into communication with the first device. To connect the two devices, the two portions of the electrical connector are mated together.

Each portion of the electrical connector includes one set of contacts or terminals adapted to be communicatively coupled to an electronic device and a second set of contacts or terminals adapted to be communicatively coupled to the other connector portion. This can be readily accomplished by designating one portion of the connector as having “male” contacts or terminals adapted to be coupled to the other connector portion's “female” contacts or terminals. Regardless of the specific design of the contacts or terminals, the two connector portions should be adapted to be easily connected and disconnected from each other to respectively electrically link and unlink the electrical devices to which they are connected.

Accordingly, each connector portion is fixedly connected to an electronic device through its remaining set of contacts or terminals. The contacts or terminals may be removably or permanently connectable to the electrical device; however, it is usually desired that the connector portion be secured to the electrical device through some physical mechanism. Typically, the connector portions are secured to electrical devices via wires or cables.

However, with a conventional electrical connector system, direct attachment of the wires or cables to two contacts of the connector system is often difficult or impossible. Accordingly, a board or paddle card is often used to provide the necessary termination geometry between the wire or cable and the respective component of the connector system.

A problem with using a transition or paddle board is that the number of solder joints required to connect the wire or cable to the connector is increased, which decreases the reliability of the connector assembly. More specifically, when a transition or paddle board is used, one solder joint is required between each wire or cable and the transition or paddle board and another solder joint is required between each contact and the transition or paddle board. In addition, the use of a transition or paddle board requires multiple transition points which produce disturbances in the electrical path.

### SUMMARY OF THE INVENTION

To overcome the problems described above, preferred embodiments of the present invention provide an electrical connector which enables a simplified termination of the cable and a variety of different types of cables and wires to be soldered directly to the contacts.

An electrical connector according to a preferred embodiment of the present invention includes a connector frame, a plurality of contacts disposed in the connector frame, and a plurality of cables, each of which includes at least one center conductor. The at least one center conductor of each of the plurality of cables is directly connected to a respective one of the plurality of contacts.

Preferably, the connector frame includes a cable support arranged to fix an orientation of the plurality of cables in the connector frame.

Preferably, the cable support includes a plurality of projections arranged such that each of the plurality of cables is fixedly disposed between adjacent ones of the plurality of projections.

According to another preferred embodiment, the cable support is defined by concave portions on opposed inner surfaces of the connector frame arranged to receive the cables therebetween. Each of the concave portions of the cable support preferably includes at least one projection arranged to contact an insulating layer of a respective one of the cables so as to fix the respective one of the cables in the connector frame.

Each of plurality of cables may be a coaxial cable.

Alternatively, each of the plurality of cables may be a twinax cable.

The electrical connector according to a preferred embodiment further includes a ground plane connected to the connector frame, wherein each of the plurality of cables includes another conductor that is electrically connected to the ground plane, and the ground plane is arranged to relieve stress on the plurality of cables.

The electrical connector according to a preferred embodiment further includes upper and lower connector housings, wherein the connector frame is disposed within the upper and lower connector housings.

An electrical connector according to another preferred embodiment of the present invention includes a connector housing including a front connector housing portion and a rear connector housing portion, a plurality of contacts disposed in the front connector housing portion, a plurality of cables, each of which includes at least one conductor. The at least one center conductor of each of the plurality of cables is directly connected to a respective one of the plurality of contacts.

Preferably, the rear connector housing portion includes a cable support arranged to fix an orientation of the plurality of cables with respect to the contacts.

The cable support preferably includes upper and lower support portions arranged such that each of the plurality of cables is fixedly disposed between the upper and lower support portions. Each of the plurality of cables may be a coaxial cable.

Alternatively, each of the plurality of cables may be a twinax cable in which the at least one center conductor of each of the plurality of cables includes two center conductors.

The electrical connector according to this preferred embodiment preferably includes a ground plane connected to the front connector housing portion, wherein each of the plurality of cables includes another conductor that is electrically connected to the ground plane.

The plurality of contacts are preferably arranged in the connector housing in a single bank.

Alternatively, the plurality of contacts may be arranged in the connector housing in more than one bank.

A method of manufacturing an electrical connector according to another preferred embodiment of the present invention includes the steps of providing a connector frame, providing a plurality of contacts in the connector frame, each of the plurality of contacts having substantially the same shape and including a portion arranged to contact a ground plane, providing a plurality of cables, each of the plurality of cables including at least one center conductor and a conductive sheath layer, providing a ground plane in the connector frame, selectively connecting the at least one center conductor of a portion of the plurality of cables directly to respective ones of the plurality of contacts, and selectively connecting the conductive sheath layer of another portion of the plurality of cables directly to the ground plane. In the step of selectively connecting the at least one center conductor of the portion of the plurality of cables directly to the respective ones of the plurality of contacts, the respective ones of plurality of contacts are cut so as to remove the portion of the contact arranged to contact the ground plane.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of the connector assembly according to a preferred embodiment of the present invention.

FIG. 2 is a perspective view of the connector assembly shown in FIG. 1 in a partially assembled state.

FIG. 3 is a perspective view of a partially assembled portion of the connector assembly shown in FIG. 1.

FIG. 4 is a top plan view of the partially assembled portion of the connector assembly shown in FIG. 3.

FIG. 5 is a side view of the partially assembled portion of the connector assembly shown in FIG. 3.

FIG. 6 is a perspective view of a connector assembly according to another preferred embodiment of the present invention.

FIG. 7 is a perspective view of the connector assembly shown in FIG. 6 in a partially assembled state.

FIG. 8 is a side view of the partially assembled portion of the connector assembly shown in FIG. 6.

FIG. 9 is a perspective view of a modification of the connector assembly shown in FIG. 1.

FIG. 10 is a front view of a modification of the connector assembly shown in FIG. 6.

FIG. 11 is a perspective view of a connector assembly according to another preferred embodiment of the present invention.

FIG. 12 is a perspective view of a partially assembled portion of the connector assembly shown in FIG. 11.

FIG. 13 is another perspective view of a partially assembled portion of the connector assembly shown in FIG. 11.

FIG. 14 is another perspective view of a partially assembled portion of the connector assembly shown in FIG. 11.

FIG. 15 is another perspective view of a partially assembly portion of the connector assembly shown in FIG. 11.

### DETAILED DESCRIPTION OF PREFERRED EMBODIMENTS

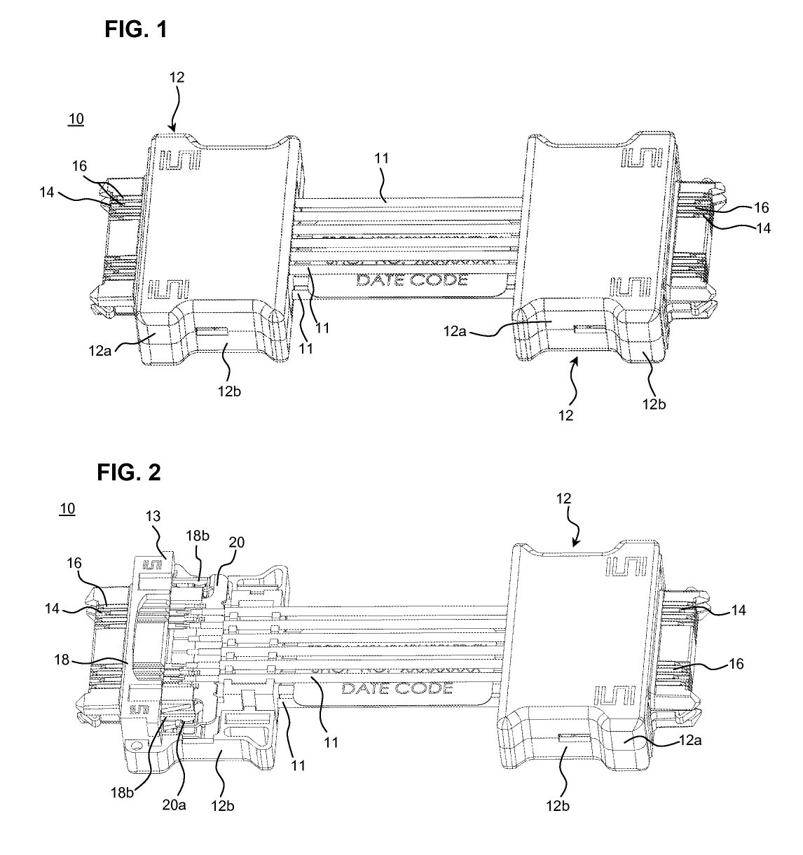

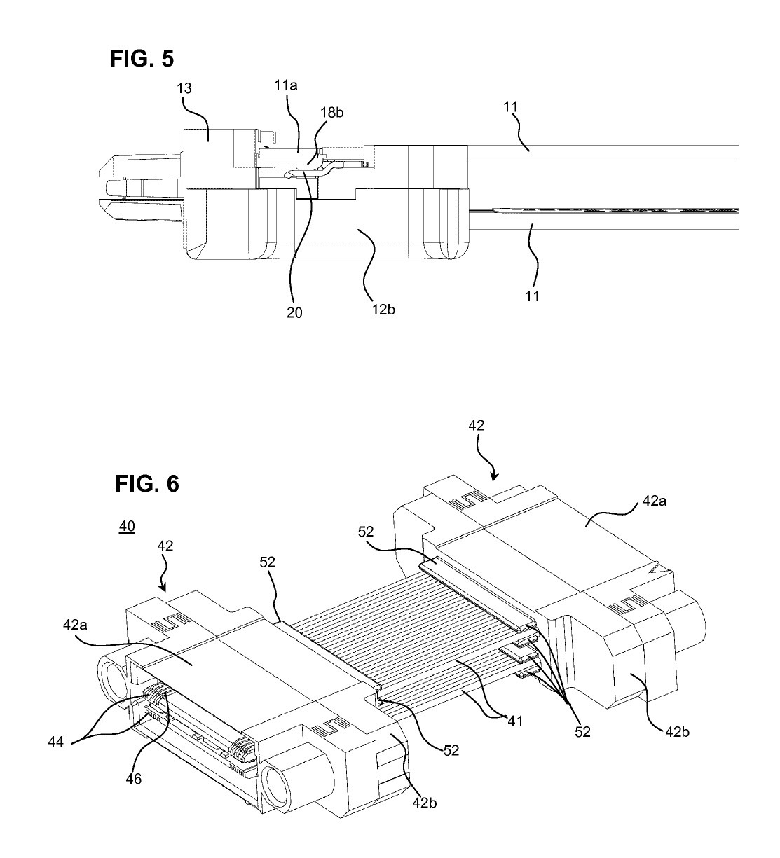

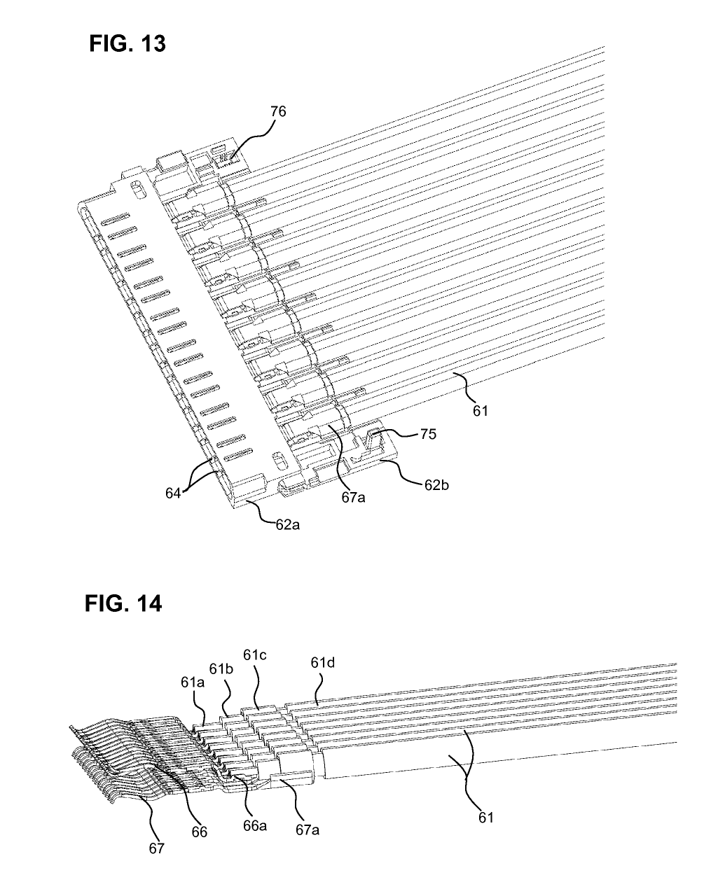

Preferred embodiments of the present invention will now be described with reference to FIGS. 1 to 15.

FIGS. 1-5 show a connector assembly 10 or a portion of the connector assembly 10 according to a preferred embodiment of the present invention.

As shown in FIG. 1, the connector assembly 10 preferably includes a plurality of cables 11 arranged in two rows which extend between connector housings 12 so as to provide electrical connection therebetween. However, one row or more than two rows of cables could be provided. In the present preferred embodiment, the cables 11 preferably are coaxial cables. However, any suitable type of cables or wires may be used, such as shield cables, ribbon cables, and coaxial ribbon cables.

The structure of the present preferred embodiment is described with respect to the upper row of cables 11 and the upper portion of the connector assembly 10. The lower row of cables and the lower portion of the connector assembly 10 include substantially the same structure. Similarly, if three or more rows are provided, then each of the other rows would include substantially the same structure.

Each connector housing 12 includes an upper housing portion 12a and a lower housing portion 12b that are separable from one another. As shown in FIGS. 2 to 5, a connector frame 13 is disposed in the connector housing 12. In the preferred embodiment shown in FIGS. 1-5, the connector assembly is a male connector assembly. However, the connector assembly may also be a female connector assembly.

The connector frame 13 includes contact guide slots 14. The contacts 16 are disposed in the contact guide slots 14 and extend through the intermediate portion 18 of the connector frame 13 such that ends 16a of the contacts 16 are exposed so that they can be connected to respective ones of the cables 11. The contact guide slots 14 accurately locate each of the contacts 16 in the connector frame 13. It should be noted that any number of contact guide slots and contacts may be provided depending on the use or application of the connector assembly 10.

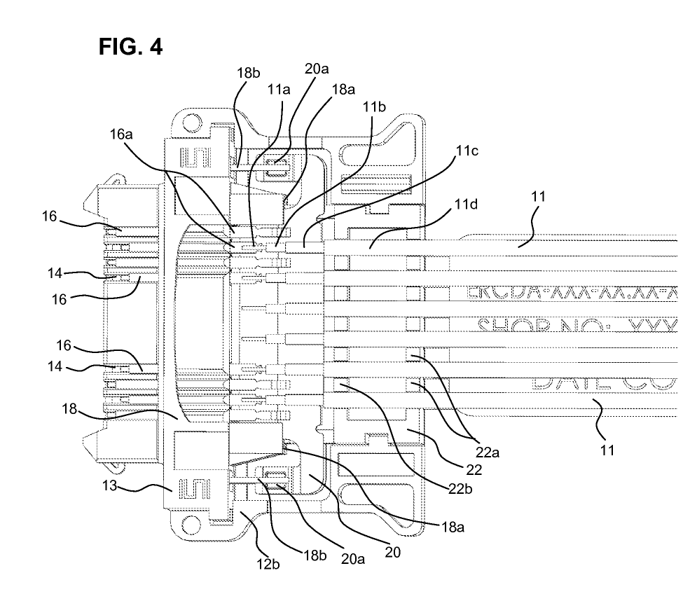

As best seen in FIG. 4, each coaxial cable 11 includes a center conductor 11a, an insulating layer 11b, a conductive sheath layer 11c, and another insulating layer 11d. The center conductor 11a is directly connected to the end 16a of a respective contact 16, and the conductive sheath layer 11c is directly connected to a ground plane 20 which is mated to the connector frame 13. In this preferred embodiment, the center conductor 11a is connected to the end 16a of a respective contact 16 via solder. Any suitable soldering method may be used to connect the center conductor 11a to the end 16a of the respective contact 16, such as hand soldering, laser soldering, induction soldering, reflow soldering, and microflame soldering. Alternatively, any suitable conductive adhesive may be used.

In order to fix the ground plane 20 in the connector housing 12, ends of the ground plane 20 are inserted into slots 18a provided in the intermediate portion 18, and pawls 18b of the intermediate portion 18 are engaged with depressions 20a of the ground plane 20. However, any suitable fixing structure may be provided to fix the ground plane 20 in the connector housing 12.

In the present preferred embodiment, the contacts 16 are arranged such that every other contact 16 is directly connected to a center conductor 11a of a respective cable 11, and the remaining contacts 16 are directly connected to the ground plane 20. However, any suitable arrangement of contacts may be used, depending on the desired function and application of the connector assembly 10. For example, the contacts 16 may be arranged in accordance with the type of signal being transmitted through the connector, such as single-ended signals or differentially paired signals.

As best seen in FIG. 4, in this preferred embodiment, each of the contacts 16 that is directly connected to a center conductor 11a has a length that is less than that of each of the remaining contacts 16 that is directly connected to the ground plane 20. More specifically, the end of each of the remaining contacts 16 connected to the ground plane 20 that is disposed in a respective contact guide slot 14 extends further outwardly than the end of each of the contacts 16 directly connected to a respective center conductor 11a. This arrangement ensures that a ground connection is established before a signal connection when mating the connector assembly 10 with another connector assembly, and ensures that the ground connection is maintained during disconnection of the signal connection when disconnecting the connector assembly 10 from another connector assembly. However, any suitable lengths for the contacts 16 may be used.

The ends 16a of the remaining contacts 16 directly connected to the ground plane 20 are defined by spring fingers. In the present preferred embodiment, the spring fingers are resiliently held against the ground plane 20 via a spring force such that no solder or other conductive adhesive is required to connect the contacts 16 to the ground plane 20. However, alternatively, the spring fingers may be soldered or welded to the ground plane 20 using any suitable method. The arrangement of the center conductors 11a of the cables 11 with respect to the ground plane 20 is used to tune the impedance of the connector assembly 10. The number and arrangement of the remaining contacts 16 directly connected to the ground plane 20 are selected based upon the type of signal being transmitted through the connector, for example, single-ended signals or differentially paired signals.

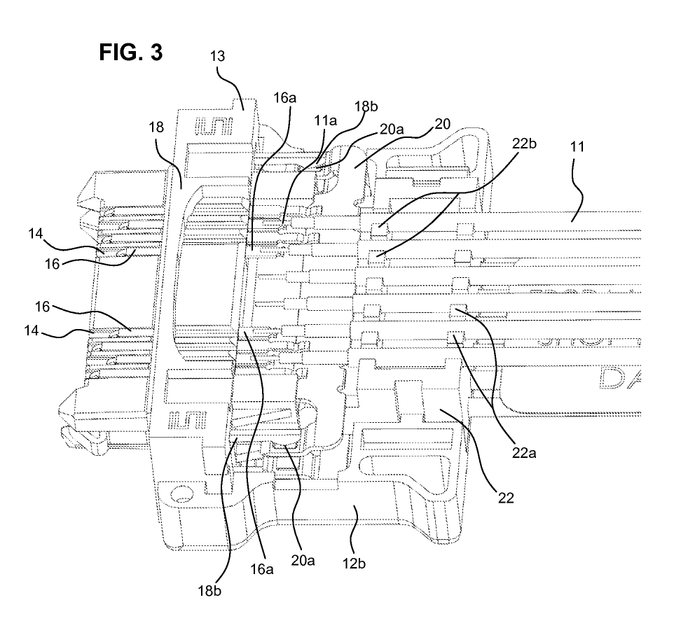

Preferably, when the connector assembly 10 is being manufactured, each of the contacts 16, including those to be connected to the center conductor 11a of the cables 11 and those to be connected to the ground plane 20, initially has substantially the same shape which corresponds to the shape of the contacts 16 that are in contact with the ground plane including the spring fingers, as shown in FIGS. 3 and 4.

Preferably, during the manufacturing process, each of the contacts 16 to be connected to the ground plane 20 is maintained in its original shape, and each of the contacts 16 to be connected to the center conductor 11a of the cables 11 is cut so as to remove the portion of the contact 16 that is to be in contact with the ground plane.

By configuring all of the contacts 16 to have the substantially the same initial shape, the same component can be used in the manufacturing process to build connector assemblies having different signal to ground ratios, single-ended connector assemblies, and differential pair connector assemblies.

The connector frame 13 further includes a cable support 22 which supports and fixes the cables 11 in a desired location and orientation. Since the cables 11 are supported and fixed by the cable support 22, the stress is reduced on the solder connections between the cables 11 and the contacts 16 and between the cables 11 and the ground plane 20. The cable support 22 includes two rows of projections 22a, 22b. Each projection 22a is spaced apart from an adjacent projection 22a by a distance that is slightly less than the diameter of the cable 11, and each of the projections 22b is similarly arranged.

With the arrangement of projections 22a, 22b according to the present preferred embodiment, the orientation of the cables 11 can be fixed in both the longitudinal and lateral directions, so as to reduce any stresses applied to the solder connection between the cables 11 and the contacts 16 or between the cables 11 and the ground plane 20. Although the projections 22a, 22b preferably are used in the present preferred embodiment, any suitable cable support may be used, such as holes in the connector frame 13, a clam shell design, overmolding, adhesives, and potting.

The cable support 22 is preferably integrally formed with connector frame 13 so as to simplify the structure of the connector assembly 10 and reduce the number of components. However, the cable support may be provided as a separate component as long as it fixes the position of the cables 11 in both the longitudinal direction and the lateral direction.

In addition to the cable support 22, the ground plane 20 is preferably arranged to reduce stresses applied to the solder connection between the cables 11 and the contacts 16.

Another preferred embodiment will now be described with reference to FIGS. 6-8.

Similar to the preferred embodiment described above, a connector assembly 40 according to the present preferred embodiment includes a plurality of cables 41 that are directly connected to contacts 46.

As shown in FIG. 6, the connector assembly 40 preferably includes a plurality of cables 41 arranged in two rows which extend between connector housings 42 so as to provide electrical connection therebetween. However, one row or more than two rows may be used. In the present preferred embodiment, the cables 41 preferably are coaxial cables. However, any suitable type of cable or wire may be used, such as shield cables, ribbon cables, and coaxial ribbon cables.

The structure of the present preferred embodiment is described with respect to the upper row of cables 41 and the upper portion of the connector assembly 40. The lower row of cables 41 and the lower portion of the connector assembly 40 include substantially the same structure. Similarly, if three or more rows are provided, then each of the other rows would include substantially the same structure.

Each connector housing 42 includes a front housing portion 42a and a rear housing portion 42b that are separable from one another. The connector assembly 40 shown in FIGS. 6-8 is a male connector assembly. However, the connector assembly may also be a female connector assembly.

The connector front housing portion 42a includes contact guide slots 44 arranged to position a plurality of contacts 46. The guide slots 44 are similar to the guide slots 14 of the preferred embodiment shown in FIGS. 1-5. The contacts 46 extend through the front housing portion 42a such that ends 46a of the contacts 46 are exposed so that they can be connected to respective ones of the cables 41. It should be noted that any number of contact guide slots and contacts may be provided depending on the use or application of the connector assembly 40.

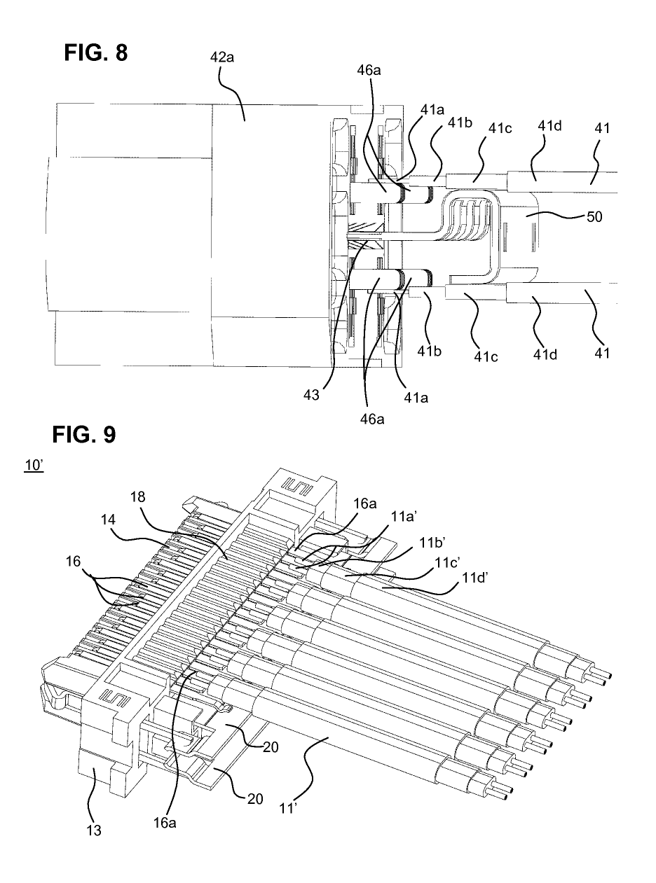

As best seen in FIG. 8, each coaxial cable 41 includes a center conductor 41a, an insulating layer 41b, a conductive sheath layer 41c, and another insulating layer 41d. The center conductor 41a is directly connected to the end 46a of a respective contact 46, and the conductive sheath layer 41c is directly connected to a ground plane 50 which is mated to the front connector housing portion 42a. In this preferred embodiment, the center conductor 41a is connected to the end 46a of a respective contact 46 via solder, and the conductive sheath 41c is connected to the ground plane 50 via solder. Any suitable soldering method may be used to connect the center conductor 41a to the end 46a of the respective contact 46, such as hand soldering, laser soldering, induction soldering, reflow soldering, and microflame soldering. Alternatively, any suitable conductive adhesive may be used.

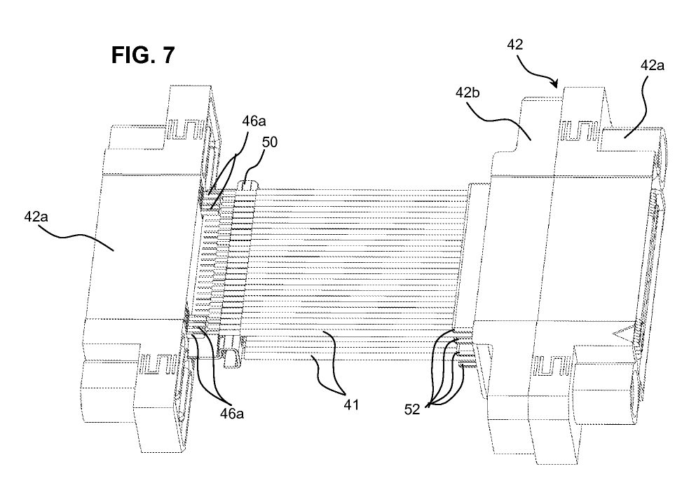

In the present preferred embodiment, in order to simplify the illustrations shown in FIGS. 6 and 7, the contacts 46 are only shown at the end portions of the rear connector housing portion 42b. Any suitable arrangement of contacts may be used, depending on the desired function and application of the connector assembly 40. For example, the contacts 46 may be arranged in accordance with the type of signal being transmitted through the connector, such as single-ended signals or differentially paired signals.

In order to fix the ground plane 50 in the front connector housing portion 42a, one edge of the ground plane 50 is press fit into a slot 43 provided in the front connector housing portion 42a. However, any suitable fixing structure may be provided to fix the ground plane 50 in the front connector housing portion 42a.

In contrast to the connector assembly 10 shown in FIGS. 1-5, which includes separate ground planes 20 for the upper and lower rows of contacts 16, the ground plane 50 shown in FIGS. 6-8 is configured to enable connection to the contacts 46 of both the upper row and the lower row.

The rear connector housing portion 42b includes cable supports 52 which extend in a rearward direction and fix the cables 41 in a desired location and orientation. The cable supports 52 are disposed above and below each row of cables 41 so as to clamp the cables 41 therebetween. Since the cables 41 are supported and fixed by the cable support 52, stress is reduced on the solder connections between the cables 41 and the contacts 46 and between the cables 41 and the ground plane 50. In addition, the rear connector housing portion 42b and the cable support 52 are configured to prevent the application of an excessively tight bend radius and to insulate all of the solder connections.

With the arrangement of the cable supports 52 according to the present preferred embodiment, the location of the cables 41 can be fixed in both the longitudinal and lateral directions, so as to reduce any stresses applied to the solder connections between the cables 41 and the contacts 46 and between the cables 41 and the ground plane 50.

The cable support 52 is preferably integrally formed with the rear connector housing portion 42b so as to simplify the structure of the connector assembly 40 and reduce the number of components. However, the cable support 52 may be provided as a separate component as long as it fixes the position of the cables 41 in both the longitudinal direction and the lateral direction.

In addition to the cable supports 52, the ground plane 50 is arranged to reduce stresses applied to the solder connection between the cables 41 and the contacts 46.

FIG. 9 shows a connector assembly 10′ according to a modification of the preferred embodiment shown in FIGS. 1-5.

The coaxial cable 11 shown in FIGS. 1-5 is replaced with a twin-ax cable 11′ as shown in FIG. 9. The twin-ax cable 11′ includes two center conductors 11a′, instead of a single center conductor 11, as in the coaxial cable 11 shown in FIGS. 1-5. The twin-ax cable 11′ also includes an insulating layer 11b′, a conductive sheath layer 11c′, and another insulating layer 11d′ which are similar to the insulating layer 11b, the conductive sheath layer 11c, and the insulating layer 11d, respectively, shown in FIGS. 3 and 4. In order to accommodate the two center conductors 11a′ of the twin-ax cable 11′, adjacent contacts 16 are connected to the two center conductors 11a′ of each twin-ax cable 11′. Similar to the cables 11 shown in FIGS. 1-5, the conductive sheath layer 11c′ is directly connected to a ground plane 20. The remaining components of the connector assembly 11′ are substantially the same as the components of the connector assembly 11 shown in FIGS. 1-5.

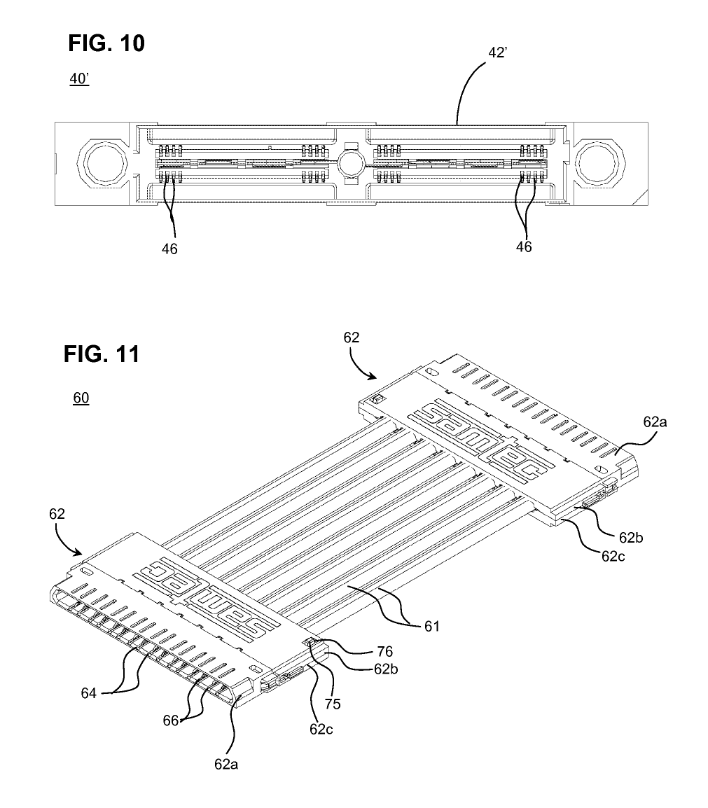

In the preferred embodiments shown in FIGS. 1-9, a single bank of contacts is preferably provided. Alternatively, two or more banks of contacts can be provided. For example, FIG. 10 shows a connector assembly 40′ that includes two banks of contacts 46 disposed in a connector housing 42′.

FIGS. 11-15 show a wafer connector assembly 60 or a portion of the wafer connector assembly 60 according to another preferred embodiment of the present invention.

The preferred embodiment shown in FIGS. 11-15 is directed to a wafer connector assembly 60 including connector housings 62 which are removably inserted into another larger connector housing (not shown). The wafer connector assembly 60 enables portions of a larger connector assembly (not shown) to be removed and replaced as required.

As shown in FIG. 11, the connector assembly 60 preferably includes a plurality of cables 61 arranged in a single row which extend between connector housings 62 so as to provide electrical connection therebetween. However, two or more rows of cables could be provided. In the present preferred embodiment, the cables 61 preferably are twin-ax cables. However, any suitable type of cable or wire may be used, such as shield cables, ribbon cables, and coaxial ribbon cables.

Each connector housing 62 includes a front housing portion 62a, an upper rear housing portion 62b and a lower rear housing portion 62c that are separable from one another. Each of the upper and lower rear housing portions 62b, 62c includes a projection 75 and an opening 76. The projection 75 and the opening 76 of the upper rear housing portion 62b are arranged to be engaged with the opening 76 and the projection 75 of the lower rear housing portion 62c, respectively, so as to align and mate the upper and lower rear housing portions 62b, 62c to one another. In this preferred embodiment, each of the upper and lower housing portions 62b, 62c preferably includes one projection 75 and one opening 76. However, any suitable aligning and mating structure may be provided in the upper and lower housing portions 62b and 62c.

In addition, although not shown, the front housing portion 62a and the upper and lower rear housing portions 62b, 62c include a corresponding alignment and mating structure to align and mate these components together. Any suitable mating structure may be used.

The front housing portion 62a includes contact guide slots 64 extending along upper and lower inner surfaces thereof. Contacts 66 and 67 are disposed in the contact guide slots 64 and extend through a rear surface of the front housing portion 62a such that ends 66a and 67a of the contacts 66 and 67 are exposed so that they can be connected to respective ones of the cables 61. The contact guide slots 64 accurately locate each of the contacts 66 and 67 in the front housing portion 62a. It should be noted that any number of contact guide slots and contacts may be provided depending on the use or application of the connector assembly 60.

In the present preferred embodiment, the contacts 66 preferably are signal contacts and the contacts 67 preferably are ground contacts. However, any suitable arrangement of the contacts 66 and 67 may be used.

As best seen in FIG. 14, each twin-ax cable 61 includes two center conductors 61a, an insulating layer 61b, a conductive sheath layer 61c, and another insulating layer 61d. The center conductors 61a are directly connected to the end 66a of a respective signal contact 66, and the conductive sheath layer 61c is directly connected to a respective ground contact 67. In this preferred embodiment, the center conductors 61a are connected to the end 66a of a respective contact 66 preferably via solder. Any suitable soldering method may be used to connect the center conductor 61a to the end 66a of the respective contact 66, such as hand soldering, laser soldering, induction soldering, reflow soldering, and microflame soldering. However, any suitable conductive adhesive may be used.

In contrast to the preferred embodiments described above with reference to FIGS. 1-10, the present preferred embodiment does not include a common ground plane, and instead, includes individual ground contacts 67.

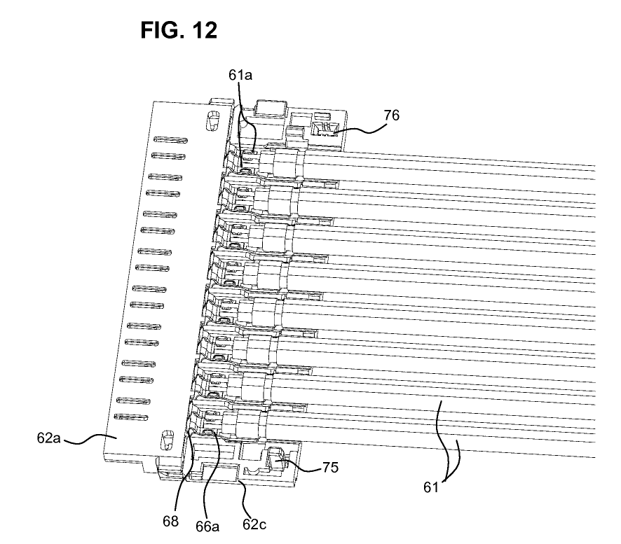

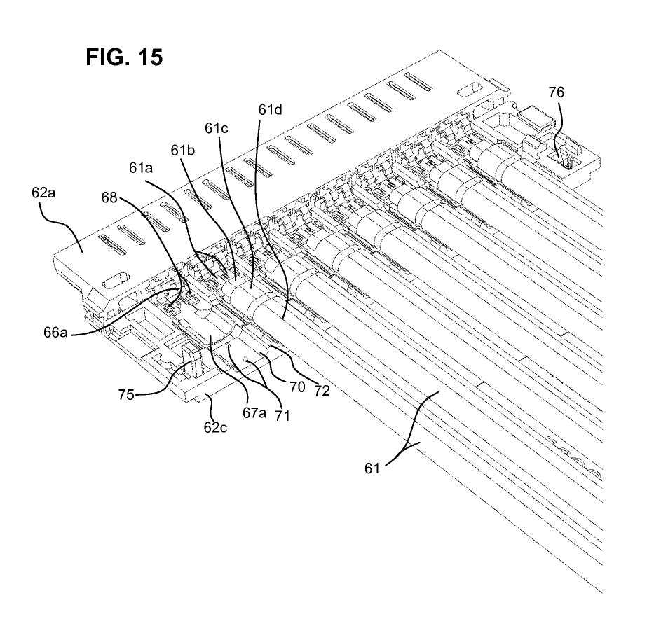

As shown in FIGS. 12 and 15, each of the ends 67a of the contacts 67 preferably has a concave shape and each of the ends 66a of the contacts 66 preferably has a projection 68 extending therefrom. The concave shape of the end 67a of the contact and the projection 68 of the end 66a of the contact 66 facilitate positioning of the center conductors 61a and the conductive sheath layer 61c with respect to the contact ends 66a and 67a. However, the contact ends 66a and 67a may have any suitable shape, such as a substantially planar shape. In addition, any other suitable structure may be provided to facilitate positioning of the center electrodes 61a and the conductive sheath layer 61c with respect to the contact ends 66a and 67a.

It should be noted that concave shape of the contacts 66 and the projections 68 extending from the contacts 66 are suitable for use in any of the preferred embodiments disclosed in the present application.

Each of the upper and lower rear housing portions 62b, 62c further include a cable support structure which supports and fixes the cables 61 in a desired location and orientation. Since the cables 61 are supported and fixed by the cable support structure provided in the upper and lower rear housing portions 62b, 62c, the stress is reduced on the solder connections between the cables 61 and the contacts 66 and between the cables 61 and the contacts 67. The cable support structure will be described with respect to the lower rear housing portion 62c as shown in FIG. 15. The cable support structure of the upper rear housing portion 62b is substantially the same as that of the lower rear housing portion 62c. Thus, the description thereof is omitted. The cable support structure is defined by concave surfaces 70 in which the cables 61 are disposed. A guiding projection 72 is provided between each adjacent concave surface 70 so as to guide each cable 61 into a respective one of the concave surfaces 70. Each of the concave surfaces 70 includes projections 71 which extend outwardly from the concave surfaces 70. When the upper and lower rear housing portions 62b and 62c are aligned with each other, the projections 71 contact the insulating layer 61d of each cable and are depressed partially into the insulating layer 61d so as to prevent the cables 61 from being moved in a longitudinal direction thereof.

With the arrangement of the concave surfaces 70, the guiding projections 72, and the projections 71, according to the present preferred embodiment, the location of the cables 61 can be fixed in both the longitudinal and lateral directions, so as to reduce any stresses applied to the solder connection between the cables 61 and the contacts 66 and 67. Although each concave surface 70 preferably includes two projections 71 in preferred embodiments of the present invention, any suitable number of projections 71 may be provided. In addition, although projections 71 are preferably used in the present preferred embodiment, any suitable cable fixing structure may be used.

The cable support structure is preferably integrally formed with upper and lower rear housing portions 62b, 62c so as to simplify the structure of the connector assembly 60 and reduce the number of components. However, the cable support may be provided as a separate component as long as it fixes the position of the cables 61 in both the longitudinal direction and the lateral direction.

In the present invention, the contacts and cables can be arranged in a single-ended arrangement or in differential pairs.

The electrical connector according to preferred embodiments of the present invention enables a simplified termination of the cable and a variety of different types of cables and wires to be soldered directly to the contacts. In addition, the paddle or transition board is no longer required, and thus, can be eliminated. Consequently, the number of solder joints required to connect the cables to the contacts is decreased by half, which greatly improves the reliability of the connector assembly.

In addition, since the paddle or transition board is no longer required, the electrical length of the connector assemblies is reduced and the impedance discontinuities and reflections will be minimized. This provides cleaner signals with less interference. Thus, the connector assembly according to preferred embodiments of the present invention is suitable for high data rate applications.

Furthermore, the cable support and the ground plane in the cable housing provide superior stress relief for the cables. Finally, the number of transition points is reduced by half, which significantly reduces the disturbances in the electrical path, which result in a better, cleaner signal.

The present invention is not limited to the preferred embodiments described above. Many alternative preferred embodiments are possible.

It should be understood that the foregoing description is only illustrative of the present invention. Various alternatives and modifications can be devised by those skilled in the art without departing from the present invention. Accordingly, the present invention is intended to embrace all such alternatives, modifications and variations which fall within the scope of the appended claims.

What is claimed is:

1. An electrical connector comprising:
a connector frame;
a plurality of contacts disposed in the connector frame;
a plurality of cables, each of the plurality of cables including at least one center conductor; wherein
the at least one center conductor of each of the plurality of cables is directly connected to a respective one of the plurality of contacts.

2. The electrical connector according to claim 1, wherein the connector frame includes a cable support arranged to fix an orientation of the plurality of cables in the connector frame.

3. The electrical connector according to claim 2, wherein the cable support includes a plurality of projections arranged to fix each of the plurality of cables between adjacent ones of the plurality of projections.

4. The electrical connector according to claim 2, wherein the cable support is defined by concave portions on opposed inner surfaces of the connector frame arranged to receive the cables therebetween.

5. The electrical connector according to claim 4, wherein each of the concave portions of the cable support includes at least one projection arranged to contact an insulating layer of a respective one of the cables so as to fix the respective one of the cables in the connector frame.

6. The electrical connector according to claim 1, wherein each of the plurality of cables is a coaxial cable.

7. The electrical connector according to claim 1, wherein
each of the plurality of cables is a twinax cable; and
the at least one center conductor of each of the plurality of cables includes two center conductors.

8. The electrical connector according to claim 1, further comprising:
a ground plane connected to the connector frame; wherein
each of the plurality of cables includes another conductor that is electrically connected to the ground plane; and
the ground plane is arranged to reduce stress on the plurality of cables.

9. The electrical connector according to claim 1, further comprising:
upper and lower connector housings; wherein
the connector frame is disposed within the upper and lower connector housings.

10. An electrical connector comprising:
a connector housing including a first connector housing portion and a second connector housing portion;
a plurality of contacts disposed in the first connector housing portion;
a plurality of cables, each of the plurality of cables including at least one conductor; wherein
the at least one center conductor of each of the plurality of cables is directly connected to a respective one of the plurality of contacts.

11. The electrical connector according to claim 10, wherein the second connector housing portion includes a cable support arranged to fix an orientation of the plurality of cables with respect to the contacts.

12. The electrical connector according to claim 11, wherein the cable support includes upper and lower support portions arranged to fix each of the plurality of cables between the upper and lower support portions.

13. The electrical connector according to claim 10, wherein each of the plurality of cables is a coaxial cable.

14. The electrical connector according to claim 10, wherein
each of the plurality of cables is a twinax cable; and
the at least one center conductor of each of the plurality of cables includes two center conductors.

15. The electrical connector according to claim 10, further comprising:
a ground plane connected to the first connector housing portion; wherein
each of the plurality of cables includes another conductor that is electrically connected to the ground plane; and
the ground plane is arranged to reduce stress on the plurality of cables.

16. The electrical connector according to claim 10, wherein the plurality of contacts are arranged in the connector housing in a single bank.

17. The electrical connector according to claim 10, wherein the plurality of contacts are arranged in the connector housing in more than one bank.

18. A method of manufacturing an electrical connector comprising the steps of:
providing a connector frame;
providing a plurality of contacts in the connector frame, each of the plurality of contacts having substantially the same shape and including a portion arranged to contact a ground plane;
providing a plurality of cables, each of the plurality of cables including at least one center conductor and a conductive sheath layer;
providing a ground plane in the connector frame;
selectively connecting the at least one center conductor of a portion of the plurality of cables directly to respective ones of the plurality of contacts; and
selectively connecting the conductive sheath layer of another portion of the plurality of cables directly to the ground plane; wherein
in the step of selectively connecting the at least one center conductor of the portion of the plurality of cables directly to the respective ones of the plurality of contacts, the respective ones of the plurality of contacts are cut so as to remove the portion of the contact arranged to contact the ground plane.
